(19) United States
(12) Patent Application Publication
(10) Pub. No.: US 2003/0134667 A1
(43) Pub. Date: Jul. 17, 2003

(54) Wireless hand-free receiver of the mobile phone built in a battery packet

(75) Inventor: Geng-horng Chung, Taipei (TW)

Correspondence Address: BACON & THOMAS, PLLC, 625 SLATERS LANE, FOURTH FLOOR, ALEXANDRIA, VA, 22314

(73) Assignee: Asoka, Inc., Taipei (TW)

(21) Appl. No.: 10/043,131

(22) Filed: Jan. 14, 2002

(51) Int. Cl. H04M 1/00

(52) U.S. Cl. 455/569; 455/572

(57) ABSTRACT

This invention is a “mobile phone's wireless hand-free handset built in the battery packet” and can particularly resolve the harassing problem found in the wired send/receive signal box of a cell phone; it is to insert a low power radio frequency send/receive module into the battery packet of a cell phone and the power of the battery packet is to supply the voltage required for the work; and through the connection port of the battery packet and the cell phone, a voice signal is inserted; and the regulation of the input/output of the voice signal is made in the radio frequency send/receive module and then the signal is sent into the air at an extreme low power; and at the same time, another radio frequency send/receive module is installed in a wireless headset to construct a signal communication network with the low power radio frequency send/receive module in the previous battery packet so that a simple and easy operation of a wireless hand-free handset of a mobile phone is completed.

### BACKGROUND OF THE INVENTION

1. FIELD OF INVENTION

One which builds a radio frequency send/receive module into a battery packet for the use of voice message transfer.

2. Description of the Related Art

Recently the innovation from the wire-type structure to the radio frequency wireless is made possible because the position of the voice plug hole of the mobile phone is connected to a radio frequency send/receive signal box, as revealed in FIG. 3. The structure is, outside the cell phone (A), to use a connecting line (B1) to connect the radio frequency send/receive signal box (B) and the cell phone (A) and a wireless headphone (C) transmits electric waves from the radio frequency send/receive signal box (B) to the phone handset (C1) and thus into the ear. As a result, a wireless mobile phone hand-free handset is formed. However, there are some obvious defects in the aforementioned merchandise. The hand-free handset of the wired mobile phone, because of the winding and dragging of its line, is very inconvenient in use and often the line ends up in winding with the limb. Consequently, the progress from the wired cell phone's hand-free handset to the wireless cell phone's hand-free handset is made possible only in that the wireless hand-free handset must add a radio send/receive signal box (B) and a connecting line (B1) beside the mobile phone (A), which likewise produces a result: a line less but an inconvenience in an additional radio frequency send/receive signal box (B). a solution to a problem leads to another problem, which remains to be resolved by other people.

### SUMMARY OF THE INVENTION

Without adding another radio frequency send/receive signal box, one can provide the consumer with the simplest and easiest and the most convenient use to render the upgrade of the use value for the industry that is the major objective of this invention.

### BRIEF DESCRIPTION OF THE DRAWINGS

FIG. 1, a representation of the structure of this invention.

FIG. 2, a functional representation of this invention.

FIG. 3, a representation of embodiment of the conventional creation.

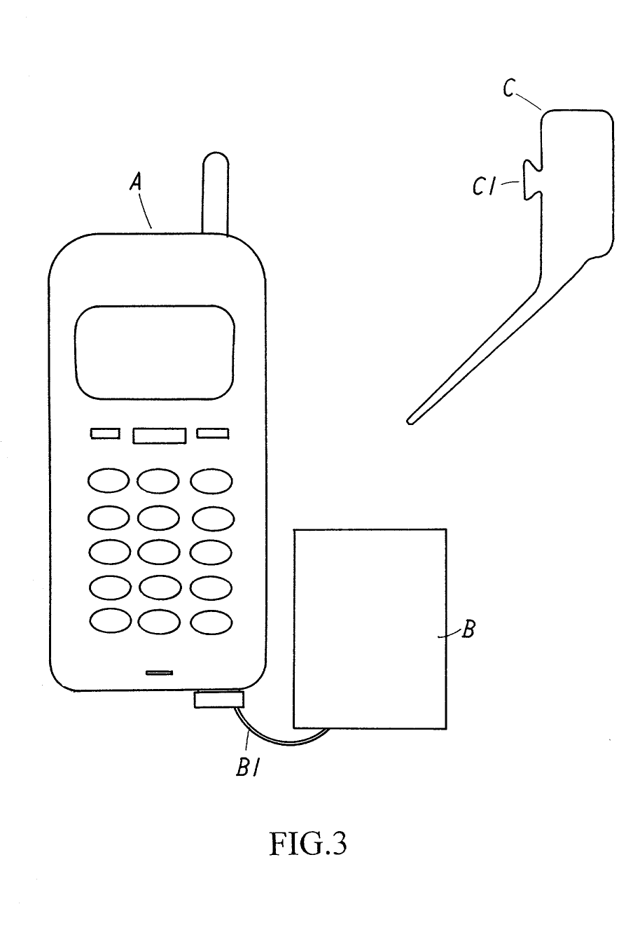

### DETAILED DESCRIPTION OF THE PREFERED EMBODIMENT

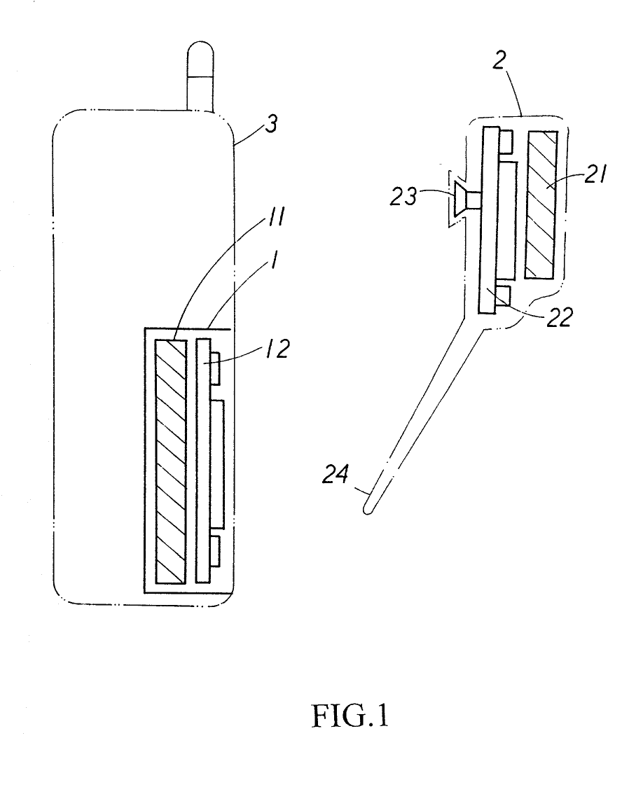

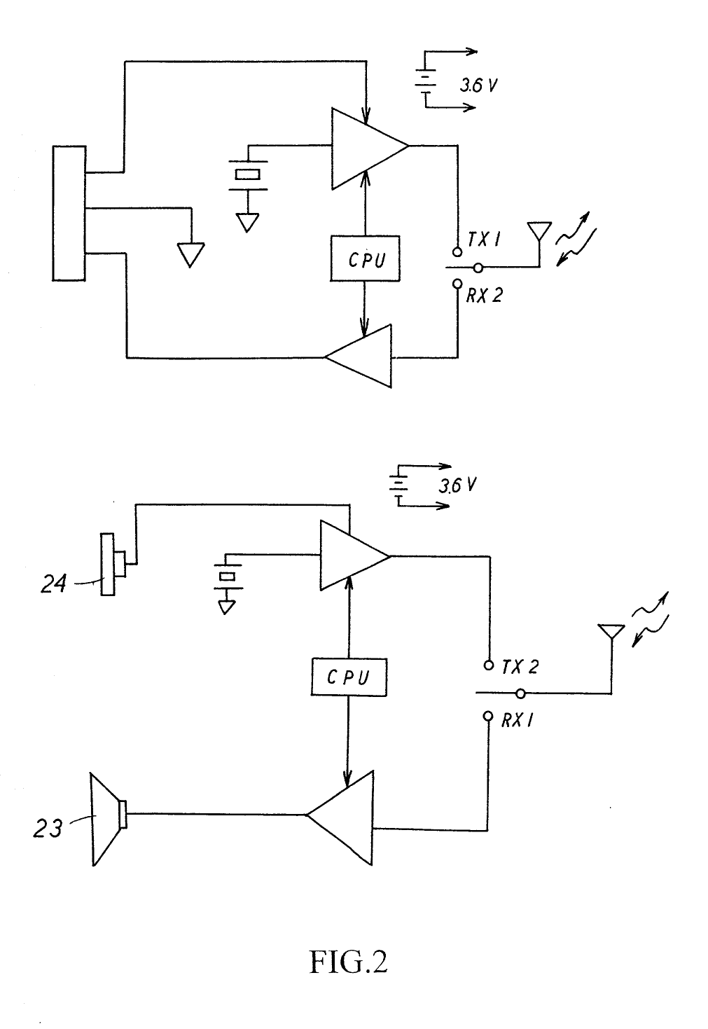

Refer to FIG. 1 and FIG. 2, in which the battery packet (1), placed within the cell phone (3), consists of a battery (11) and a radio frequency send/receive module (12), the power of which is supplied directly by the battery (11). And the in-and-out of the signal is connected with the existing voice signal connection port in the battery packet (1);

In addition to a speaker (23) and a microphone (24), the wireless headset (2) also consists of a battery (21) and a radio frequency send/receive module (22), whose power is likewise supplied directly by the battery (21);

In this way, refer to FIG. 2, in which after the mobile phone (3) displays the input phone number it will automatically pick up the phone, the voice signal of which will be led into the radio frequency send/receive module (12) in the battery packet (1) through the connection port and, after the voice signal is regulated, will be transmitted into the air at an extreme low transmission power. And the radio frequency send/receive module (22) of the wireless headset (2) hanging on the ear receives the magnetic waves transmitted by the mobile phone (3) from the air. The magnetic waves, after being restored to voice signals, are sent to the speaker (23) for phone to be picked up.

And the battery (21) in the wireless headset (2) can supply the needed power as well as for the microphone (24). The radio frequency send/receive module (22) which leads the voice signal to the wireless headset (2) carries out the regulation of the radio frequency and sends the signal into the air, which is in turn received by the radio send/receive module (2) in the battery packet (1) of the mobile phone (3) and which, after being regulated, is led into the mobile phone (3) through the connection port of the battery packet (1). Thus the function of the voice signal to send/receive between two mobile phones is completed. In this way, the connection of the magnetic waves in the air resolves the defect found in the wired transmission and achieves the true wireless handheld effect.

The content revealed by this invention, in addition to avoiding the winding and harassing of the line and the burden of the radio frequency send/receive signal box (B), also because the magnetic waves sent to the air are not limited to directional indication, can also achieve the top secret and a light and convenient and nimble effect. To sum up above, this invention, which uses the combination of each element and can achieve the expected objectives described above, is already of utility value for the industry and can completely conform to the elements of progressiveness and practicability for the application for the invention patent creation. According to the law, provided with the document, the patent application is filed. Hopefully your office will grant the patent for this case very early.

What is claimed is:

1. A “wireless hand-free headset of the mobile phone built in the battery packet” consists of:
A battery packet, which is placed in the cell phone and consists of a battery and a radio frequency send/receive module, whose power is supplied directly by the battery. The in-and-out of the signal is connected with the existing voice signal connection port in the battery packet;
A wireless headset, which consists of a battery and a radio frequency send/receive module, whose power likewise is supplied directly by the battery;
In this way, it is the one that transmits the signal into the air at an extreme low transmission power and at the same time another radio frequency send/receive module in the wireless headset constructs a signal communication network with the low power radio frequency send/receive module in the previous battery packet and then a simple and easy operation of the wireless hand-free headset of the cell phone is completed.
